(19) United States
(12) Patent Application Publication
(10) Pub. No.: US 2013/0050631 A1
(43) Pub. Date: Feb. 28, 2013

(54) Substrate, Liquid Crystal Display Panel, Liquid Crystal Display Device, and Sealant Coating Method

(71) Applicants: Chihhsien LI, Shenzhen (CN); Chunliang Lee, Shenzhen (CN)

(72) Inventors: Chihhsien LI, Shenzhen (CN); Chunliang Lee, Shenzhen (CN)

(21) Appl. No.: 13/375,423

(22) PCT Filed: Sep. 15, 2011
(86) PCT No.: PCT/CN11/79693

§ 371 Date: Nov. 30, 2011

(30) Foreign Application Priority Data
Aug. 26, 2011 (CN) 201110249284.4

(51) Int. Cl. G02F 1/1339

(52) U.S. Cl. 349/153; 349/158; 349/190

(57) ABSTRACT

The present invention discloses a substrate, a LCD panel, a LCD device and a method of sealant coating, wherein the substrate of said LCD panel comprises one or more quadrangular display areas surrounded and formed by sealant; the starting points of the sealant around said display area overlap the ending points to form an overlap section; wherein said overlap section is positioned at a corner of said display area. Because the application connections are just at the corner, the extra sealant can be directly cut off during cutting; in addition, the contamination by material extrusion after pressing caused by overly thick sealant coating at the connections can be avoided; and the man-hour of multiple cuttings can be reduced. Because the sealant overlap section is at the corner of the display area and will not diverge from the display area, the difficulty in controlling the width of the lines is solved.

### TECHNICAL FIELD

The present invention relates to the field of liquid crystal displays (LCDs), particularly to a substrate, a LCD panel, a LCD device and A method of sealant coating.

### BACKGROUND

A LCD device comprises a LCD panel. A LCD panel is always formed by cutting the large-size panel group in accordance with the predetermined size; the large-size panel group is formed by gluing the array substrate comprising a thin-film transistor (TFT) to the filter substrate comprising multiple color filters, wherein one of the substrates shall be coated with sealant before gluing to form several quadrangular areas; each area is a display area of the LCD panel and its size accords with the size of the LCD panel to be cut; liquid crystals are filled in said areas, and the two substrates are glued by hot pressing and are cut along the circumference of the sealant after gluing to form the LCD panel of the required size. The process of coating sealant in the prior art starts from one of the frames of each display area, and ends at positions exceeding the starting position, so that an overlap section is formed so as to ensure the sealing performance. Because it is difficult to control the accuracy, the sealant in the overlap section is often too much. The problem of mutual contamination, such as the contamination to the liquid crystals, is easy to occur after pressing, so that the performance of the display is affected; in addition, too much sealant in the overlap section lead to the difficulty in controlling the required width of the sealant line.

The U.S. Pat. No. 7,408,614 discloses a sealing graph structure and a formation method thereof. As shown in FIG. 1, the application process starts from the outside of an area to form the starting section; the formal application process is performed on one incurvated side in the display area; the application process ends with sealant coated onto the excurved side to form the ending section; and the starting section intersects the ending section to form the overlap section. Because the overlapping area is small, the problem that excessive sealant is accumulated in the overlap section can be effectively avoided. However, because both the starting section and the ending section in the method are excurved, the overlap section will deviate from the frame so that the width of the frame of the overlap section is obviously larger than that of the other three frames of the display area; and the difficulty in controlling the required width of the sealant line still exists after pressing; in addition, because the overlap section is on the frame, it is difficult to cut levelly the part of the overlap section during cutting.

### SUMMARY

The aim of the present invention is to provide a substrate for a LCD panel, a LCD panel, a LCD device and a sealing method with which it is easy to process the sealant overlap section levelly and control the the width of the sealant line.

The purpose of the present invention is achieved by the following technical schemes.

A substrate for LCD panel comprises one or more quadrangular display areas surrounded and formed by sealant; the starting points of the sealant around said display area overlap the ending points to form an overlap section, and wherein said overlap section is positioned at one corner of said display area.

The starting points and the ending points of said sealant continue to extend outside said corner to respectively form a starting section and an ending section, and the overlapping area of said starting section and the ending section form the overlap section. By such design, without deliberately controlling the accuracy of the application, the display area can be reliably sealed, and the excessive sealant in the overlap section can be avoided.

Said starting section and the ending section are linear sections which are perpendicular to each other.

Said starting section and the ending section are arc sections.

The incurvated sides of said starting section and the ending section are mutually and oppositely arranged.

The excurved sides of said starting section and the ending section are mutually and oppositely arranged.

A LCD panel comprises a substrate, said substrate comprises one or more quadrangular display areas surrounded and formed by sealant; the starting points of the sealant around said display area overlap the ending points to form an overlap section, wherein said overlap section is positioned at one corner of said display area.

A LCD device, said LCD device uses the aforementioned LCD panel.

A method of sealant coating, for manufacturing LCD devices, comprises the following steps:

A: Coating sealant starting from one corner of the preset display area of the substrate to be coated, continuing around the display area and ending the application process at the corner

Preferably, in said step A, the application process starts from the outside of the display area and then continues to said corner to form the starting section; the application process ends at said corner and then continues to extend outwards to form the ending section; the overlapping area of said starting section and the ending section forms the overlap section. Without deliberately controlling the accuracy of the application, the display area can be reliably sealed without excessive sealant in the overlap section.

Preferably, in said step A, said starting section and said ending section are linear sections which are perpendicular to each other. This is one embodiment.

Preferably, in said step A, said starting section and said ending section are arc sections. This is another embodiment.

Preferably, the incurvated sides of said starting section and said ending section are mutually and oppositely arranged. This is one embodiment.

Preferably, the excurved sides of said starting section and said ending section are mutually and oppositely arranged. This is one embodiment.

In the present invention, because the application connections of the sealant are just at the corner, the extra sealant can be directly cut off during cutting; in addition, the contamination by material extrusion after pressing caused by overly thick sealant coating at the connections can be avoided; and the man-hour of multiple cuttings can be reduced. Because the sealant overlap section is at the corner of the display area and will not diverge from the display area, the difficulty in controlling the width of the lines is solved; and because the overlap section is positioned at the corner where two frames of the display area meet, the overlap section is subjected to two cutting operations during the cutting of the frame of the display area, which improves the degree of flatness of the overlap section.

### BRIEF DESCRIPTION OF FIGURES

FIG. 1 is the schematic diagram of the display area and the sealant overlap section of the prior art;

FIG. 2 is the schematic diagram of the display area and the sealant overlap section of the present invention;

FIG. 3 is the amplified view of the schematic diagram of the sealant overlap section of embodiment 1 of the present invention;

FIG. 4 is the amplified view of the schematic diagram of the sealant overlap section of embodiment 2 of the present invention;

FIG. 5 is the amplified view of the schematic diagram of the sealant overlap section of embodiment 3 of the present invention;

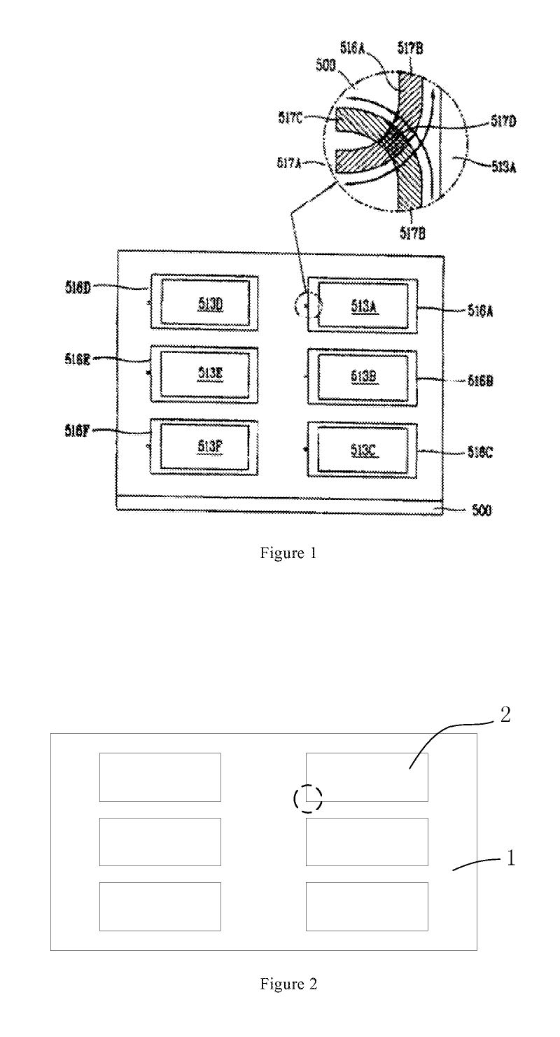

Wherein: 1. array substrate; 2. display area; 3. starting section; 3. ending section; 5. overlap section.

### DETAILED DESCRIPTION

The present invention will further be described in detail in accordance with the figures and the preferred embodiments.

Said substrate for LCD panel of one embodiment of the present invention comprises one or more quadrangular display areas surrounded and formed by sealant; the starting points of the sealant around said display area overlap the ending points to form an overlap section, and wherein said overlap section is positioned at a corner of said display area. Said substrate can comprise only one display area, and the substrate integrally forms a display area used for the LCD device; and said substrate can also comprise multiple display areas and can be cutted to form the LCD panels of the LCD devices.

The starting points and the ending points of said sealant continue to extend outside said corner to respectively form a starting section and an ending section, and the overlapping area of said starting section and ending section forms the overlap section. By such design, without deliberately controlling the accuracy of the application, the display area can be reliably sealed without excessive sealant, and the extended starting section and the ending section are cut off in the subsequent cutting process.

The method of sealant coating used for manufacturing a LCD device comprises the following steps:

A: Coating sealant starting from one corner of the preset display area of the substrate to be coated, continuing around the display area and ending the application process at the corner.

The method of sealant coating of said LCD device will further be described in detail in accordance with the preferred embodiments and the array substrate used as one example of the substrates.

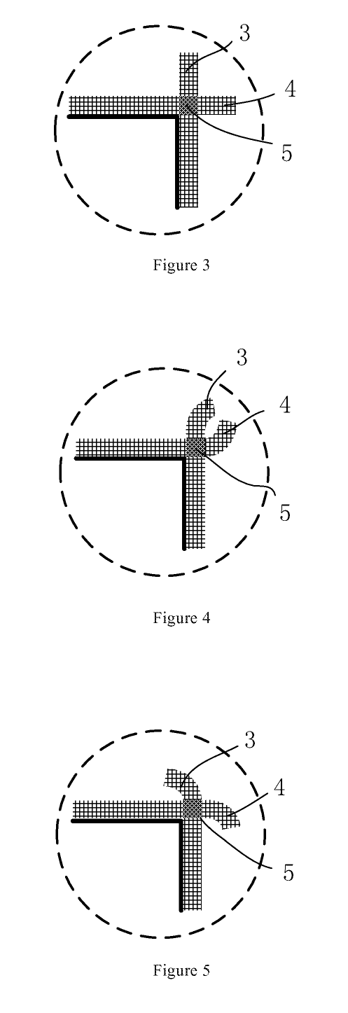

Embodiment 1. As shown in FIG. 2 and FIG. 3, multiple display areas are defined on the array substrate in accordance with the required size of the liquid crystal panels; the sealant coating process starts from one corner of one display area, continues in a linear mode from the corner onto one side of the display area, and ends by extending from the corner toward the outside of the display area in a linear mode. The starting section is formed between the starting position of application process and said corner; the ending section is formed between the ending position of application process and said corner; and the starting section and the ending section are perpendicular to each other. The starting section and the ending section intersect at said corner to form said overlap section. To use, first the liquid crystals are filled into said display area; then the display area is covered by the filter substrate for heat bonding; finally, the frame of the display area is cutted to form the panel of said LCD device. The frame of the display area is cut closely and the sealant starting section and ending section can be both cut off, and a flat LCD panel can be obtained without any additional cutting process.

Embodiment 2. As shown in FIG. 2 and FIG. 4, multiple display areas are defined on the array substrate in accordance with the required size of the liquid crystal panels. The sealant coating process starts from one corner of one display area; to preferably ensure that a completely sealed display area is formed, the position away from the display area is selected for starting the application; the application continues by entering from the corner toward one side of the display area in an arc mode; the application ends by extending from the corner to the outside of the display area in an arc mode. The starting section is formed between the starting position of application process and said corner; the ending section is formed between the ending position of application process and said comer, and the incurvated sides of the starting section and the ending section are mutually and oppositely arranged. The starting section and the ending section intersect at said corner to form said overlap section. To use, first the liquid crystals are filled into said display area; then the display area is covered by the filter substrate for heat bonding; finally, the frame of the display area is cutted to form the panel of said LCD device. The frame of the display area is cut closely and the sealant starting section and ending section can be both cut off, and a flat LCD panel can be obtained without any additional cutting process.

Embodiment 3. As shown in FIG. 2 and FIG. 5, multiple display areas are defined on the array substrate in accordance with the required size of the liquid crystal panels. The sealant coating process starts from one corner of one display area; to preferably ensure that a completely sealed display area is formed, the position away from the display area is selected for starting the application; the application continues by entering from the corner toward one side of the display area in an arc mode; the application ends by extending from the corner to the outside of the display area in an arc mode. The starting section is formed between the starting position of application process and said corner; the ending section is formed between the ending position of application process and said corner, and the excurved sides of the starting section and the ending section are mutually and oppositely arranged. The starting section and the ending section intersect at said corner to form said overlap section. To use, first the liquid crystals are filled into said display area; then the display area is covered by the filter substrate for heat bonding; finally, the frame of the display area is cutted to form the panel of said LCD device. The frame of the display area is cut closely and the sealant starting section and ending section can be both cut off, and a flat LCD panel can be obtained without any additional cutting process.

The above embodiments can also be coated to the filter substrates; the shapes and the mutual positions of said starting section and the ending section are not limited to the aforementioned forms; all the embodiments as described herein should be considered to belong to the protection scope of the present invention: application starts from the outside of the display area, continues by entering into one side of the display area from any corner of the display area, and ends by extending from the position of the corner to the outside the display area. In the present invention, because the application connections are just at the corner, the extra sealant can be directly cut off during cell cutting; in addition, the contamination by material extrusion after pressing caused by overly thick sealant coating at the connections can be avoided; and the man-hour of multiple cuttings can be reduced. Because the sealant overlap section is at the corner of the display area and will not diverge from the display area, the difficulty in controlling the width of the lines is solved; and because the overlap section is positioned at the corner where two frames of the display area meet, the overlap section is subjected to two cutting operations during the cutting of the frame of the display area, which improves the degree of flatness of the overlap section.

The present invention is described in detail in accordance with the above contents with the specific preferred embodiments. However, this invention is not limited to the specific embodiments. For the ordinary technical personnel of the technical field of the present invention, on the premise of keeping the conception of the present invention, the technical personnel can also make simple deductions or replacements, and all of which should be considered to belong to the protection scope of the present invention.

We claim:

1. A substrate for LCD panels, comprising: one or more quadrangular display areas surrounded and formed by sealant; the starting points of the sealant around said display area overlap the ending points to form an overlap section, and said overlap section is positioned at a corner of said display area.

2. The substrate for LCD panels of claim 1, wherein the starting points and the ending points of said sealant continue to extend outside said corner to respectively form a starting section and an ending section, and the overlapping area of said starting section and the ending section form an overlap section.

3. The substrate for LCD panels of claim 2, wherein said starting section and the ending section are linear sections which are perpendicular to each other.

4. The substrate for LCD panels of claim 2, wherein said starting section and the ending section are arc sections.

5. The substrate for LCD panels of claim 4, wherein the incurvated sides of said starting section and the ending section are mutually and oppositely arranged.

6. The substrate for LCD panels of claim 4, wherein the excurved sides of said starting section and the ending section are mutually and oppositely arranged.

7. A LCD panel, comprising: a substrate; said substrate comprises one or more quadrangular display areas surrounded and formed by sealant; the starting points of the sealant around said display area overlap the ending points to form an overlap section, and said overlap section is positioned at a corner of said display area.

8. A LCD device, wherein said LCD device uses the LCD panels of claim 7.

9. A method of sealant coating, for manufacturing LCD devices, comprising the following step A: Coating sealant from one corner of the preset display area of the substrate to be coated, continuing around the display area, and ending the application at the corner.

10. The method of sealant coating of claim 9, for manufacturing LCD devices, wherein in said step A, application starts from the outside of the display area, continues to said corner to form the starting section, ends by returning to said corner and continuing to extend outside to form the ending section; and the overlapping area of said starting section and the ending section forms the overlap section.

11. A method of sealant coating of claim 10, for manufacturing LCD devices, wherein in said step A, the starting section and the ending section are linear sections which are perpendicular to each other.

12. A method of sealant coating of claim 10, for manufacturing LCD devices, wherein in said step A, the starting section and the ending section are arc sections.

13. A method of sealant coating of claim 12, for manufacturing LCD devices, wherein the incurvated sides of said starting section and the ending section are mutually and oppositely arranged.

14. A method of sealant coating of claim 12, for manufacturing LCD devices, wherein the excurved sides of said starting section and the ending section are mutually and oppositely arranged.
